(19) United States
(12) Patent Application Publication
(10) Pub. No.: US 2014/0007960 A1
(43) Pub. Date: Jan. 9, 2014

(54) FUEL DELIVERY PIPES

(71) Applicant: AISAN KOGYO KABUSHIKI KAISHA, Obu-shi (JP)

(72) Inventor: Kensuke NIWA, Nagoya-shi (JP)

(73) Assignee: AISAN KOGYO KABUSHIKI KAISHA, Obu-shi (JP)

(21) Appl. No.: 13/935,165

(22) Filed: Jul. 3, 2013

(30) Foreign Application Priority Data
Jul. 3, 2012 (JP) 2012-149394

(51) Int. Cl. F02M 55/02; F16L 55/115

(52) U.S. Cl. CPC F02M 55/02; F16L 55/115
USPC 137/561 A; 138/89

(57) ABSTRACT

A fuel delivery pipe may include a main pipe portion and a plurality of distribution pipe portions. A cap member may close an opening of an open end of the main pipe portion. The cap member may include a cap body, a fusion bonding member fusion-bonded to the closed side end of the main pipe portion, and a connection support portion provided between the fusion bonding member and the cap body. When a load is applied to the cap body while the fusion bonding member is bonded to the open end of the main pipe portion, the connection support portion may mitigate potential stress that may be applied to a fusion bonded region.

This application claims priority to Japanese patent application serial number 2012-149394, the contents of which are incorporated herein by reference.

### BACKGROUND OF THE INVENTION

1. Field of the Invention

Embodiments of the present invention relate to resin fuel delivery pipes configured to distribute fuel to cylinders of internal combustion engines. More specifically, the embodiments relate to fuel delivery pipes having closing caps that are fusion-bonded to main pipe portions for closing the same.

2. Description of the Related Art

Automobiles may have internal combustion engines serving as drive sources. Fuel may be supplied to the internal combustion engine from a fuel tank. The internal combustion engine may be equipped with a plurality of, for example, four cylinders. The fuel from the fuel tank may be distributed to each of the cylinders. To this end, the internal combustion engine may be equipped with a fuel delivery pipe for distributing the fuel to each of the cylinders. The fuel delivery pipe may include a main pipe portion into which fuel is supplied from the fuel tank, and a plurality of distribution pipe portions for distributing the fuel to each cylinder from the main pipe portion (see, for example, Japanese Laid-Open Patent Publication No. 2000-161179).

The main pipe portion may be a linearly extending hollow tubular member formed through resin injection molding. One end of the main pipe portion thus formed may be opened so as to allow communication with the fuel tank, and the other end thereof may be closed by a cap member. More specifically, the cap member may be attached to an open end of a pipe main body of the main pipe portion through fusion bonding.

The pressure of the supplied fuel flowing into the main pipe portion may be applied to the inner peripheral surface of the main pipe portion having the open end closed by the cap member. Thus, the strength of the pipe main body of the main pipe portion and the strength of the cap member must be high enough to withstand this pressure. Here, if the strength of the cap member is simply increased, the pressure received by the cap member may be applied as stress to a fusion-bonded region where the cap member is bonded to the pipe main body. Therefore, it may occur that the bonding strength at the fusion-bonded portion may be lowered or lost.

Therefore, there has been a need in the art for a technique of maintaining the bonding strength at a fusion-bonded region where a cap member is bonded to a pipe main body of a fuel delivery pipe.

### SUMMARY OF THE INVENTION

A fuel delivery pipe may include a main pipe portion and a plurality of distribution pipe portions. A cap member may close an opening of an open end of the main pipe portion. The cap member may includes a cap body, a fusion bonding member fusion-bonded to the open end of the main pipe portion, and a connection support portion provided between the fusion bonding member and the cap body. The connection support portion may mitigate a potential stress that may be applied to a fusion bonded region such as that where the fusion bonding member is bonded to the open end of the main pipe portion.

### BRIEF DESCRIPTION OF THE DRAWINGS

FIG. 1 is a side view, as seen from the right-hand side, of a fuel delivery pipe incorporating a cap member according to a first embodiment of the present invention;

FIG. 2 is a sectional view, taken along line II-II in FIG. 1, of the cap member ;

FIG. 3 is a sectional view similar to FIG. 2 but illustrating a cap member according to a second embodiment;

FIG. 4 is a sectional view similar to FIG. 2 but illustrating a cap member according to a third embodiment;

FIG. 5 is a sectional view similar to FIG. 2 but illustrating a cap member according to a fourth embodiment;

FIGS. 6(a) through 6(c) are sectional views, taken along line VI-VI in FIG. 4, illustrating variations of a rib structure; and

FIGS. 7(a) through 7(c) are sectional views, taken along line VII-VII in FIG. 5, illustrating variations of a rib structure.

### DETAILED DESCRIPTION OF THE INVENTION

Each of the additional features and teachings disclosed above and below may be utilized separately or in conjunction with other features and teachings to provide improved cap members and fuel delivery pipes having such cap members. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings.

In one embodiment, a fuel delivery pipe may include a main pipe portion and a plurality of distribution pipe portions. The main pipe portion may receive a supply of fuel from a fuel storage device, may have an inlet for receiving the supply of fuel, and may have an open end with an opening. The plurality of distribution pipe portions may communicate with the main pipe portion for distributing fuel from the main pipe portion to respective engine cylinders. A cap member may close the opening of the open end of the main pipe portion. The cap member may include a cap body, a fusion bonding member fusion-bonded to the open end of the main pipe portion, and a connection support portion provided between the fusion bonding member and the cap body. The rigidity of the connection support portion may be lower than the rigidity of the cap body.

With this arrangement, the connection support portion may exhibit a larger permissible deformation amount as compared with the cap body. The term “permissible deformation amount” is used to mean a deformation amount that can be permitted without impairing the function of the cap member.

Thus, the stress caused by the pressure load applied to the cap body may act on the fusion bonding member via the connection support portion. It may result in deformation of the connection support portion. Thus, due to the deformation of the connection support portion, it is possible to reduce the stress caused by the pressure load acting on the fusion bonding member. In other words, the connection support portion may mitigate the stress applied to the fusion bonding member.

As a result, it is possible to more reliably prevent the bonding of the fusion bonding member from being lowered or lost. This can make it possible to maintain high fusion bonding strength.

The connection support portion may include a part extending along an extending direction of the main pipe portion. With this arrangement, it is possible to select a simple configuration in forming the connection support portion. As a result, it is possible to simplify the molding process of the cap member.

Additionally or alternatively, the connection support portion may include a part extending along an extending direction of the main pipe portion. With this arrangement, the deforming direction of the connection support portion may lie in substantially the same direction of the pressure load applied to the cap body. In this way, the connection support portion can be more easily deformed, making it possible to further reduce the stress of the pressure load applied to the fusion bonding member.

In the following, fuel delivery pipes according to embodiments of the present invention will be described with reference to the drawings.

### First Embodiment

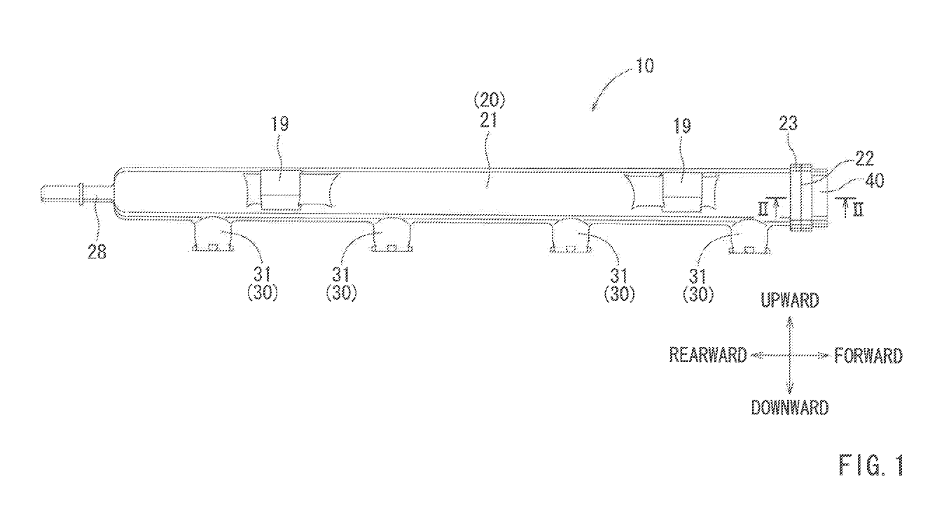

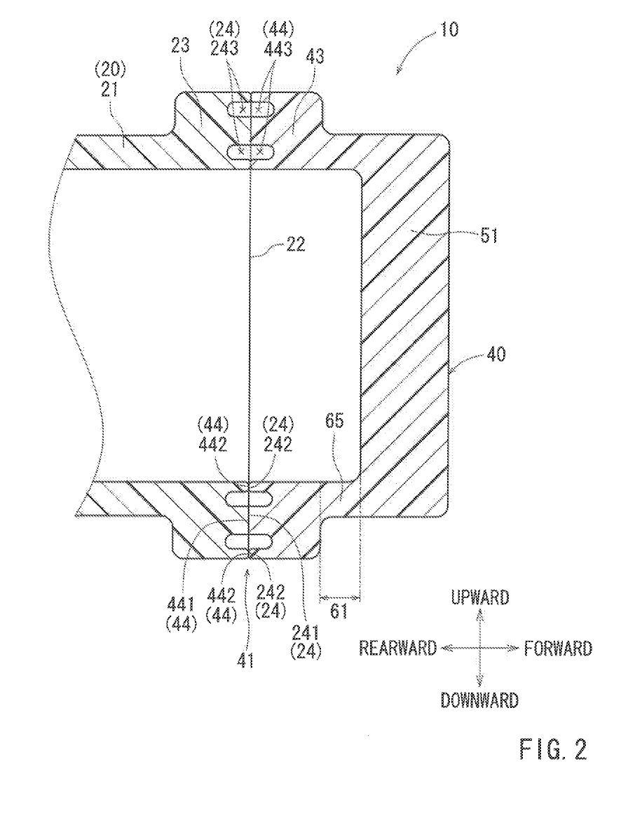

For the purpose of explanation, in the following description, the upper, lower, front, rear, left, and right sides as seen in FIGS. 1 and 2 may correspond to the upper, lower, front, rear, left, and right sides of a fuel delivery pipe 10. That is, FIG. 1 is a side view, as seen from the right-hand side, of the fuel delivery pipe 10. The fuel delivery pipe 10 shown in FIG. 1 may be designed for use with a four-cylinder internal combustion engine (not shown). That is, the fuel delivery pipe 10 may have an elongated main pipe portion 20 and four distribution pipe portions 30 extending in a direction crossing the direction in which this main pipe portion 20 extends. The main pipe portion 20 may receive a supply of fuel from a fuel tank (not shown) storing fuel. Fuel may be delivered to the engine cylinders from the main pipe portion 20 via the distribution pipe portions 30. An injector (not shown) may be attached to each of the distribution pipe portions 30 for injecting fuel into each cylinder. The fuel delivery pipe 10 may be a resin-molded product having the main pipe portion 20 and the distribution pipe portions 30 integrated together.

The fuel delivery pipe 10 may be formed by integrally molding a pipe main body 21 having the main pipe portion 20 along with a distribution pipe member 31 having the distribution pipe portions 30. As shown in FIG. 1, the pipe main body 21 having the main pipe portion 20 may be formed as a substantially tubular member having an inlet tube 28 at the rear end. Fuel may be supplied from the fuel tank (not shown) to the pipe main body 21 via the inlet tube 28.

A cap member 40 may be attached to an open front end 22 of the pipe main body 21 for closing the same. The open front end 22 will be hereinafter also referred to as a “closed-side end 22”. The distribution pipe portions 31 and the distribution pipe portions 30 may protrude downwardly from the pipe main body 21 that includes the main pipe portion 20. Four distribution pipe portions 31 may be provided at equal intervals along the length of the pipe main body 21. An injector mount portion (not shown) may be formed at the lower end of each distribution pipe portion 31. Support portions 19 having support holes for mounting to the internal combustion engine may be formed on the pipe main body 21 so as to protrude outwardly therefrom.

The cap member 40 may be made of resin and may be attached to the closed side end 22 through fusion bonding. When the cap member 40 is thus attached to the closed side end 22, the opening of the closed side end 22 formed at the time of molding the pipe main body 21 may be closed. This closed side end 22 may be formed to be open so as to establish communication between the interior and the exterior of the pipe main body 21. That is, the closed side end 22 may be formed such that it can be opened to the outside from which it is also supported by. It may need to be opened because a main pipe portion core (not shown) used for molding the pipe main body 21 (the main pipe portion 20) may protrude outwards from the closed side end 22 of the pipe main body 21. The main pipe portion core may be supported by an external support mechanism (not shown) during the molding process of the pipe main body 21 (the main pipe portion 20).

A fusion-bonding flange portion 23 may be formed at the end edge of the closed side end 22. This fusion-bonding flange portion 23 may protrude radially outwards from the pipe main body 21 (the main pipe portion 20) and may serve as an outer flange allowing fusion bonding of the cap member 40 described below.

According to a first embodiment, the attaching structure of the cap member 40 will be described next.

As shown in FIG. 2, the front end surface of the fusion-bonding flange portion 23 may be formed with a fusion bonding portion 24 so as to be fusion-bonded through heating such bonding can occur, for example, by using a heater, such as an electric heater. The fusion bonding portion 24 may be fusion-bonded to a fusion bonding portion 44 of the cap member 40. This fusion bonding portion 24 of the pipe main body 21 may include a fusion bonding portion main part 241, a contour maintaining part 242, and grooves 243. The fusion bonding portion main part 241 may be melted through heating to be fusion-bonded to a fusion bonding portion main part 441 of the cap member 40. The contour maintaining part 242 may serve to maintain the external configuration of the fusion bonding portion 24 that was just fusion-bonded. The grooves 243 may serve to accommodate fusion-bonding burrs that may be generated through the fusion bonding between the fusion bonding main parts 241 and 441.

The cap member 40 may be formed to have the fusion bonding member 41, a cap body 51, and a connection support portion 65 that are integrated with each other. The fusion bonding member 41 may be configured to be substantially the same as the fusion bonding flange portion 23 of the pipe main body 21 (the main pipe portion 20). That is, the fusion bonding member 41 may have a fusion bonding flange portion 43 facing the fusion bonding flange portion 23 of the pipe main body 21. Like an ordinary outer flange, the fusion bonding flange portion 43 may be formed so as to protrude radially outwards from the cap member 40. The rear end surface of the fusion bonding flange portion 43 may include the fusion boding portion 44 to be fusion-bonded through heating. The fusion bonding portion 44 may be fusion-bonded to the fusion bonding portion 24 of the pipe main body 21. Like the fusion bonding portion 24 of the pipe main body 21 described above, the fusion bonding portion 44 of the cap member 40 may include a fusion bonding portion main part 441, a contour maintaining part 442, and grooves 443. That is, the fusion bonding portion main part 441 may be melted with heat for fusion bonding the pipe main body 21 and the fusion bonding portion 24 to each other. The contour maintaining part 442 may serve to maintain the outer configuration of the fusion bonding portion 44 thus fusion-bonded. The grooves 443 may serve to accommodate fusion bonding burrs that may be generated through the fusion bonding between the fusion bonding main parts 241 and 441.

The cap body 51 may close the opening of the main pipe portion 20, and may be arranged at the foremost side of the cap member 40. Thus, the extension range of the cap body 51 may be set in conformity with the opening of the closed side end 22 of the pipe main body 21. More specifically, the extension range of the cap body 51 may be set to close at least a part of the opening of the closed side end 22, or the entire opening range of the closed side end 22. As shown in FIG. 2, the cap body 51 may have a wall thickness that is larger than the wall thickness of the pipe main body 21 so that it may exhibit high rigidity.

The connection support portion 65 may be formed between the fusion bonding member 41 and the cap body 51. The connection support portion 65 shown in FIG. 2 may extend from the fusion bonding member 41 in the longitudinal direction or the extending direction of the main pipe portion 20 within a range 61. The connection support portion 65 may have a wall thickness smaller than the wall thickness of the cap body 51. Thus, the rigidity of this connection support portion 65 may be lower than that that of the cap body 51.

In the fuel delivery pipe 10 according to the first embodiment, the connection support portion 65 is provided between the fusion bonding member 41 and the cap body 51 of the cap member 40. Therefore, the stress of the pressure load applied to the cap body 51 may act on the fusion bonding member 41 via the connection support portion 65. Here, the rigidity of the connection support portion 65 may be lower than the rigidity of the cap body 51. As a result, the connection support portion 65 may exhibit a larger permissible deformation amount as compared with the cap body 51. The term “permissible deformation amount” is used to mean a deformation amount that can be permitted without impairing the function of the cap member 40. Thus, the stress of the pressure load applied to the cap body 51 may act on the fusion bonding member 41 via the connection support portion 65, while causing the deformation of the connection support portion 65. Thus, due to the deformation of the connection support portion 65, it is possible to reduce the stress of the pressure load acting on the fusion bonding member 41. As a result, it is possible to more securely prevent the bonding of the fusion bonding member 41 from being lost, making it possible to maintain high fusion bonding strength. Further, in the fuel delivery pipe 10 according to the first embodiment, the connection support portion 65 extends from the fusion bonding portion 41 along the extending direction of the main pipe portion 20, so that it is possible to select a simple configuration in forming the connection support portion 65. As a result, it is possible to simplify the molding process of the cap member 40.

### Second Embodiment

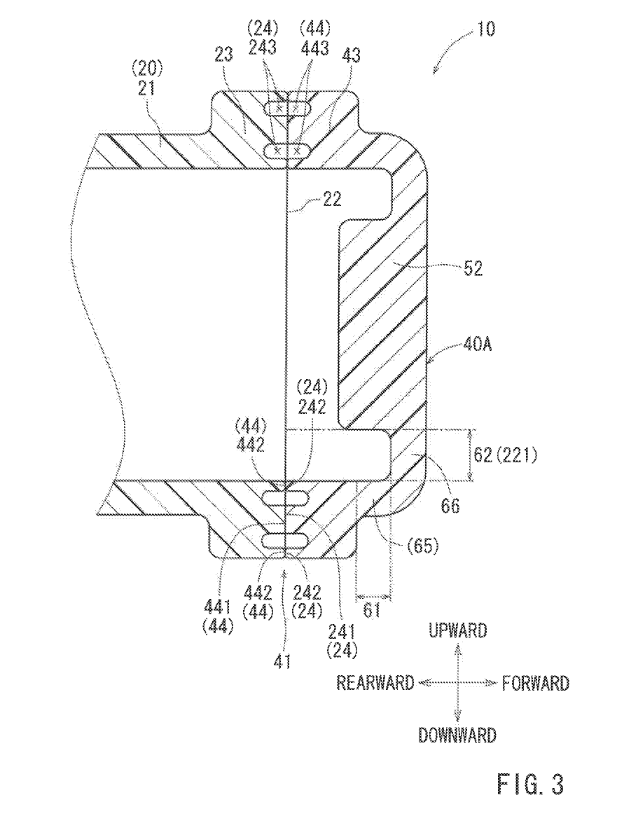

Next, an attaching structure of a cap member 40A according to a second embodiment will be described with reference to FIG. 3. The attaching structure shown in FIG. 3 is a modification of the attaching structure shown in FIG. 2. The attaching structure of the cap member 40A according to the second embodiment differs from the attaching structure of the cap member 40 of the first embodiment in that of the structure of the cap body 51 and that of the connection support portion 65. Except for the cap member 40, the construction of components may be used in both first and second embodiments. For example, the construction of components such as the pipe main body 21, etc. and the construction of the fusion bonding member 41 of the cap member 40 of the first embodiment may be also applied to the attaching structure of the cap member 40A of the second embodiment. Thus, in FIG. 3, like members are given the same reference numerals as the first embodiment, and the description of these members will not be repeated.

In the second embodiment, the extension range of a cap body 52 of the cap member 40A is reduced as compared with that of the cap body 51 of the cap member 40 of the first embodiment. More specifically, the area of inner surface of the cap body 52, excluding a peripheral edge portion 221 positioned on the outer peripheral side of the cap body 52, is smaller than that of the opening of the closed side opening end 22. The peripheral edge portion 221 is opposed to the outer peripheral edge of the opening of the closed side end 22. This cap body 52 may have a wall thickness larger than the wall thickness of the pipe main body 21 so that it may exhibit high rigidity.

A connection support portion 66 according to the second embodiment may include the peripheral edge portion 221 opposing the opening of the main pipe portion 20 (the range indicated by reference numeral 62 in the drawing) in addition to a part corresponding to the connection support portion 65 of the first embodiment. The connection support portion 66 may be formed to be bent in a direction orthogonal to the extending direction of the main pipe portion 20 from a position proximal to the fusion bonding member 41. Thus, the length of the part of the connection support portion 66, which corresponds to the connection support portion 65 of the first embodiment and extends in the longitudinal direction along the extending direction of the main pipe portion 20, may be so small as to be little or nothing. The connection support portion 66 may also have a wall thickness smaller than the wall thickness of the cap body 51, and its rigidity may be lower than that of the cap body 51.

In the fuel delivery pipe according to the second embodiment, the connection support portion 66 includes the peripheral edge portion 221 opposing the opening of the main pipe portion 20. Therefore, the stress of the pressure load applied to the cap body 52 may be applied to the fusion bonding member 41 via the connection support portion 66, with the connection support portion 66 being deformed. In particular, the deformed direction of the connection support portion 66 may be substantially the same as the direction of the pressure load applied to the cap body 52. Accordingly, the connection support portion 66 can be more easily deformed, making it possible to further reduce the stress of the pressure load applied to the fusion bonding member 41.

### Third and Fourth Embodiments

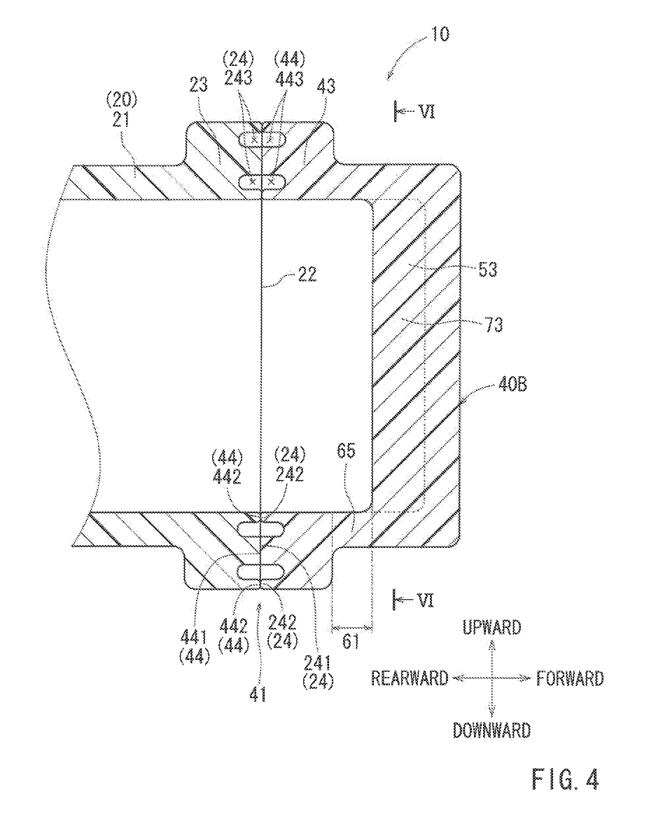

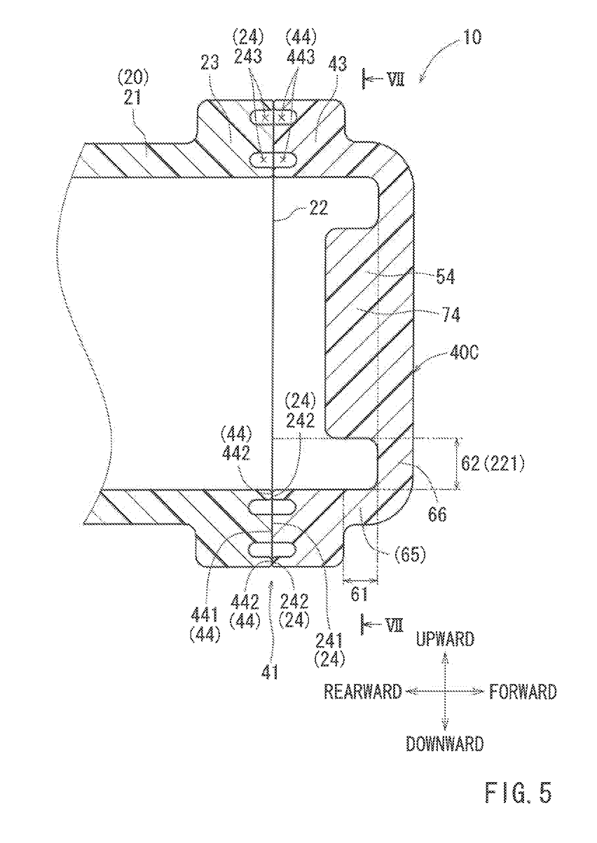

Next, an attaching structure of a cap member 40B according to a third embodiment and an attaching structure of a cap member 40C according to a fourth embodiment will be described with reference to FIGS. 4 and 5. FIG. 4 is a sectional view of the attaching structure of the cap member 40B according to the third embodiment that is similar to the attachment structure of the cap member 40 shown in FIG. 2 of the first embodiment but is different from the first embodiment in that the rigidity of the attachment structure is enhanced by a rib structure 73. FIG. 5 is a sectional view of the attaching structure of the cap member 40C according to the fourth embodiment that is similar to the attachment structure of the cap member 40A shown in FIG. 3 of the second embodiment but is different from the second embodiment in that the rigidity of the attachment structure is enhanced by a rib structure 74. Thus, the attachment structures of the third and fourth embodiments are modifications of the attachment structures of the first and second embodiments, respectively. Therefore, in FIGS. 4 and 5, like members are given the same reference numerals as the first and second embodiments and the description of these members will not be repeated.

The cap member 40B and the cap member 40C according to the third and fourth embodiments may differ from the cap member 40 and the cap member 40A of the first and second embodiments in the configurations of the cap bodies 51 and 52, respectively. Each of the cap bodies 51 and 52 according to the first and second embodiments may have a wall thickness larger than that of the pipe main body 21, thereby achieving an enhancement in rigidity. On the other hand, a cap body 53 of the cap member 40B according to the third embodiment may include the rib structure 73 for achieving an enhancement in rigidity. Similarly, a cap body 54 of the cap member 40C according to the fourth embodiment may include the rib structure 74 for achieving an enhancement in rigidity. Thus, in the cap body 53 according to the third embodiment, an enhancement in rigidity may be achieved by the rib structure 73 instead of setting the large wall thickness of the cap body 51 as in the first embodiment. Also in the cap body 54 according to the fourth embodiment, an enhancement in rigidity may be achieved by the rib structure 74 by avoiding the large wall thickness of the cap body 52 as in the second embodiment.

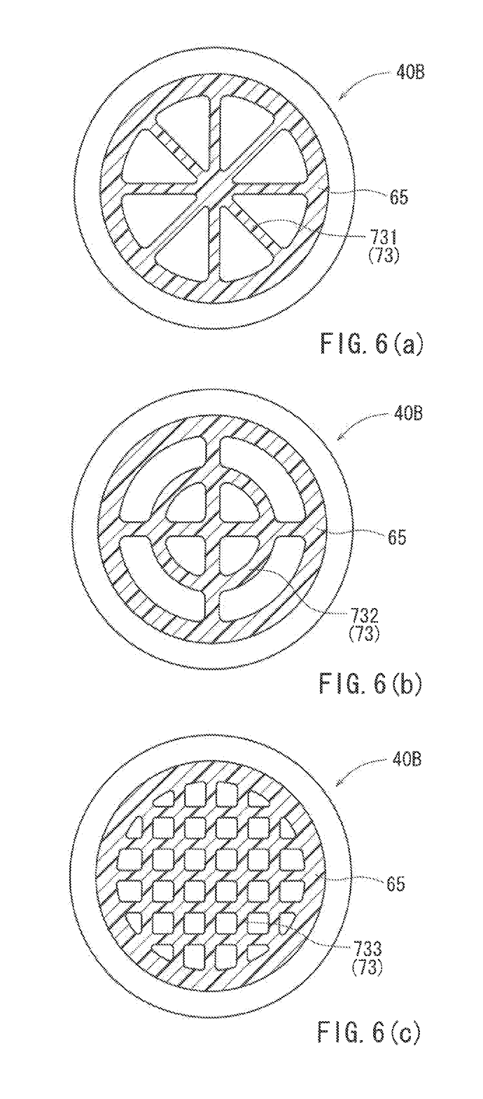

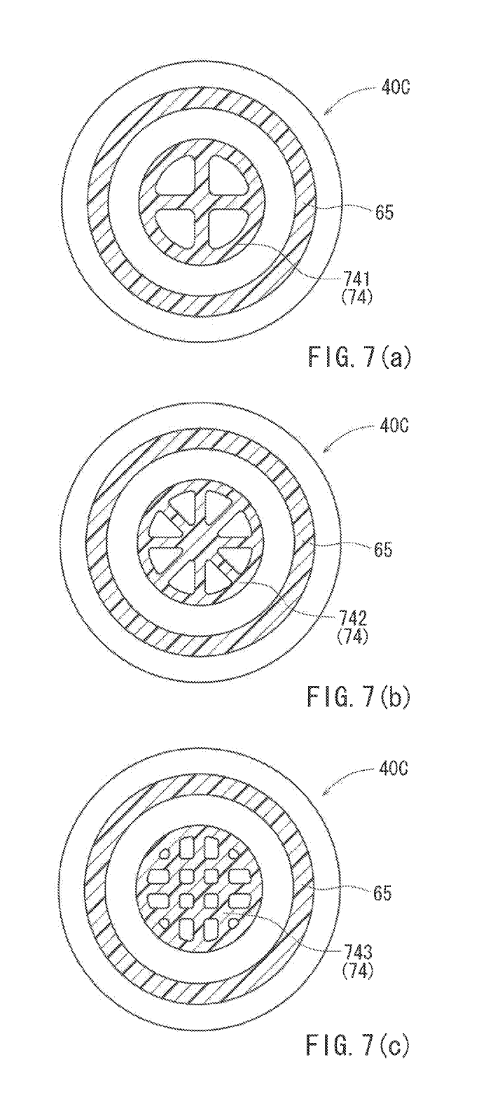

The rib structures 73 and 74 of the third and fourth embodiments may have various configurations. FIGS. 6(a), 6(b) and 6(c) are sectional views, taken along line VI-VI in FIG. 4, illustrating various configurations of the rib structure 73 of the third embodiment. FIGS. 7(a), 7(b) and 7(c) are sectional views, taken along line VII-VII in FIG. 5, illustrating various configurations of the rib structure 74 of the fourth embodiment.

Thus, the variations of the rib structure 73 may include a rib structure 731 having radially extending ribs as shown in FIG. 6(a), a rib structure 732 having an intermediate circular rib in addition to radially extending ribs as shown in FIG. 6(b), and a rib structure 733 having ribs arranged in a grid pattern as shown in FIG. 6(c).

The variations of the rib structure 74 may include a rib structure 741 having an intermediate circular rib and ribs arranged in a crisscross pattern within the circular rib as shown in FIG. 7(a), a rib structure 742 having an intermediate circular rib and ribs arranged in an asterisk pattern as shown in FIG. 7(b), and a rib structure 743 having an intermediate circular rib and ribs arranged in a grid pattern as shown in FIG. 7(c).

Also in the case where the rigidity of the cap body is enhanced by the rib structure 73, 74 as in the third and fourth embodiments, it is possible to attain the same advantages as the first and second embodiments described above.

### Other Possible Modifications

The above embodiments may be modified in various ways. For example, the connection support portion 65 according to the first embodiment extends from the fusion bonding member 41 along the extending direction of the main pipe portion 20, and the connection support portion 66 according to the second embodiment described includes a part (peripheral edge portion 221) opposing the opening of the main pipe portion 20. In this way, the connection support portion may include one or both of the parts from the fusion bonding portion along the extending direction of the main pipe portion (the range indicated by reference numeral 61), and the part opposing the opening of the main pipe portion (the range indicated by reference numeral 62). Thus, if desired, the connection support portion may include only the part opposing the opening of the main pipe portion (the range indicated by reference numeral 62).

Further, in the embodiments described above, the fusion bonding portion 24 of the fusion bonding flange portion 23 and the fusion bonding portion 44 of the cap member 44 are fusion-bonded by using the electric heater. However, the fusion bonding portions 24 and 44 may be fusion-bonded by using any other suitable techniques, such as a heat-plate fusion bonding technique, a vibration fusion bonding technique, an ultrasonic fusion bonding technique, a spin fusion bonding technique and a laser fusion bonding technique.

Further, the fuel delivery pipe 10 of the above embodiments are designed for use with a four-cylinder internal combustion engine. However, the fuel delivery pipe may be designed for used with an internal combustion engine having a plurality of cylinders in a number other than four.

What is claimed is:

1. A fuel delivery pipe comprising:
a main pipe portion configured to receive a supply of fuel from a fuel storage device, the main pipe portion having an inlet for receiving the supply of fuel and a closed side end with an opening; and
a plurality of distribution pipe portions communicating with the main pipe portion and configured to distribute fuel from the main pipe portion to respective engine cylinders; and
a cap member configured to close the opening of the closed side end of the main pipe portion; wherein:
the cap member includes a cap body, a fusion bonding member fusion-bonded to the closed side end of the main pipe portion, and a connection support portion provided between the fusion bonding member and the cap body; and
the connection support portion having a rigidity lower than a rigidity of the cap body.

2. The fuel delivery pipe according to claim 1, wherein the connection support portion includes a part extending along an extending direction of the main pipe portion.

3. The fuel delivery pipe according to claim 1, wherein the connection support portion includes a part opposed to a peripheral portion of the opening of the main pipe portion in an extending direction of the main pipe portion.

4. The fuel delivery pipe according to claim 1, wherein a wall thickness of the connection support portion is smaller than a wall thickness of the cap body.

5. The fuel delivery pipe according to claim 1, further comprising a rib structure provided on the cap body.

6. The fuel delivery pipe according to claim 1, wherein a wall thickness of the cap body is larger than a wall thickness of the main pipe portion.

7. The fuel delivery pipe according to claim 1, wherein the cap body, the fusion bonding member and the connection support portion are made of resin and molded integrally with each other.

8. A cap member used for closing an open end of a main pipe portion of a fuel delivery pipe, comprising:
a cap body,
a fusion bonding member having an opening and configured to be fusion-bonded to the open end of the main pipe portion, and
a connection support portion provided between the fusion bonding member and the cap body;
wherein a rigidity of the connection support portion is lower than a rigidity of the cap body.

9. The cap member according to claim 8, wherein the connection support portion includes a part extending along an axis of the opening of the fusion bonding member.

10. The cap member according to claim 8, wherein the connection support portion includes a part opposed to a peripheral portion of the opening of the fusion bonding member.

11. The cap member according to claim 8, wherein a wall thickness of the connection support portion is smaller than a wall thickness of the cap body.

12. The cap member according to claim 8, further comprising a rib structure provided on the cap body.

13. The cap member according to claim 8, wherein a wall thickness of the cap body is larger than a wall thickness of the main pipe portion.

14. The cap member according to claim 8, wherein the cap body, the fusion bonding member and the connection support portion are made of resin and molded integrally with each other.
